(19) United States
(12) Patent Application Publication
(10) Pub. No.: US 2023/0365155 A1
(43) Pub. Date: Nov. 16, 2023

(54) VIRTUAL FIELDS DRIVING RELATED OPERATIONS

(71) Applicant: AUTOBRAINS TECHNOLOGIES LTD, Tel Aviv-Yafo (IL)

(72) Inventors: Armin Biess, Tel-Aviv (IL); Isaac Misri, Tel-Aviv (IL); Julius Engelsoy, Tel-Aviv (IL); Igal Raichelgauz, Tel Aviv (IL)

(73) Assignee: AUTOBRAINS TECHNOLOGIES LTD, Tel Aviv-Yafo (IL)

(21) Appl. No.: 18/350,702

(22) Filed: Jul. 11, 2023

Related U.S. Application Data
(63) Continuation-in-part of application No. 17/823,069, filed on Aug. 29, 2022.
(60) Provisional application No. 63/368,154, filed on Jul. 11, 2022.
(60) Provisional application No. 63/260,839, filed on Sep. 1, 2021.

(51) Int. Cl. B60W 60/00; B60W 40/076; B60W 40/107; B60W 50/14; G06N 3/092

(52) U.S. Cl. CPC B60W 60/001; B60W 40/076; B60W 40/107; B60W 50/14; G06N 3/092; B60W 2050/146; B60W 2552/15; B60W 2554/00

(57) ABSTRACT

A method for field related driving, the method includes obtaining object information regarding one or more objects located within an environment of the vehicle; determining, by using one or more neural network (NNs), and based on the object information, one or more virtual elastic fields and one or more virtual inelastic fields of the one or more objects; and determining, based on the one or more virtual elastic fields and the one or more virtual inelastic fields, a virtual force for use in applying a driving related operation of the vehicle, wherein the virtual force is associated with a physical model and representing an impact of the one or more objects on a behavior of the vehicle.

### CROSS REFERENCE

This application is a continuation in part of U.S. Pat. Application 17/823,069 filing date Aug. 29, 2022, that claims priority from U.S. provisional application 63/260,839 which is incorporated herein by reference. This application claims priority from U.S. provisional patent serial number 63/368,154 filing date Jul. 11, 2022 which is incorporated herein in its entirety.

### BACKGROUND

Autonomous vehicles (AVs) could help vastly reduce the number of traffic accidents and CO₂ emissions as well as contribute to a more efficient transportation system. However, today’s candidate AV technologies are not scalable in the following three ways:

Limited field of view, lighting and weather challenges, and occlusions all lead to detection error and noisy localization/kinematics. In order to deal with such poor real-world perception output, one approach to AV technology is to invest in expensive sensors and/or to integrate specialized infrastructure into the road network. However, such an endeavor is very costly and-in the case of infrastructure-geographically limited, and therefore cannot lead to generally accessible AV technology.

AV technology which is not based on costly hardware and infrastructure relies entirely on machine learning and hence data to handle real-world situations. In order to deal with detection error as well as to learn a good enough driving policy for the complex task of driving, a vast amount of data and computational resources are required and still there are edge cases that are not handled correctly. The common denominator in these edge cases is that the machine learning model does not generalize well to unseen or confusing situations and due to the black-box nature of deep neural networks it is difficult to analyze faulty behavior.

Current road-ready automated driving is implemented in the form of separate ADAS functions such as ACC, AEB, and LCA. To arrive at fully autonomous driving would require seamlessly joining existing ADAS functions together as well as covering any currently non-automated gaps by adding more such functions (e.g. lane change, intersection handling etc.). In short, current automated driving is not based on a holistic approach that can readily be extended to produce full autonomous driving.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a method;

FIG. 3 illustrates an example of a method;

FIG. 4 illustrates an example of a method;

FIG. 5 is an example of a vehicle;

FIGS. 6-9 illustrate examples of situations and of perception fields;

FIG. 10 illustrates an example of a method;

FIG. 11 illustrates an example of a secne; and

FIG. 12 illustrates an example of a virtual force.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the units and/or modules that are illustrated in the application, may be implemented in hardware and/or code, instructions and/or commands stored in a non-transitory computer readable medium, may be included in a vehicle, outside a vehicle, in a mobile device, in a server, and the like.

The vehicle may be any type of vehicle that a ground transportation vehicle, an airborne vehicle, and a water vessel.

The specification and/or drawings may refer to an image. An image is an example of a media unit. Any reference to an image may be applied mutatis mutandis to a media unit. A media unit may be an example of sensed information unit (SIU). Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to a sensed information unit (SIU). The SIU may be of any kind and may be sensed by any type of sensors - such as a visual light camera, an audio sensor, a sensor that may sense infrared, radar imagery, ultrasound, electro-optics, radiography, LIDAR (light detection and ranging), a thermal sensor, a passive sensor, an active sensor, etc. The sensing may include generating samples (for example, pixel, audio signals) that represent the signal that was transmitted, or otherwise reach the sensor. The SIU may be one or more images, one or more video clips, textual information regarding the one or more images, text describing kinematic information about an object, and the like.

Object information may include any type of information related to an object such as but not limited to a location of the object, a behavior of the object, a velocity of the object, an acceleration of the object, a direction of a propagation of the object, a type of the object, one or more dimensions of the object, and the like. The object information may be a raw SIU, a processed SIU, text information, information derived from the SIU, and the like.

An obtaining of object information may include receiving the object information, generating the object information, participating in a processing of the object information, processing only a part of the object information and/or receiving only another part of the object information.

The obtaining of the object information may include object detection or may be executed without performing object detection.

A processing of the object information may include at least one out of object detection, noise reduction, improvement of signal to noise ratio, defining bounding boxes, and the like.

The object information may be received from one or more sources such as one or more sensors, one or more communication units, one or more memory units, one or more image processors, and the like.

The object information may be provided in one or more manners - for example in an absolute manner (for example - providing the coordinates of a location of an object), or in a relative manner - for example in relation to a vehicle (for example the object is located at a certain distance and at a certain angle in relation to the vehicle.

The vehicle is also referred to as an ego-vehicle.

The specification and/or drawings may refer to a processor or to a processing circuitry. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly - any reference to object detection is applicable mutatis mutandis to a pattern detection.

Although successful driving is contingent upon circumnavigating surrounding road objects based on their location and movement, humans are notoriously bad at estimating kinematics. We suspect that humans employ an internal representation of surrounding objects in the form of virtual force fields that immediately imply action, thus circumventing the need for kinematics estimation. Consider a scenario in which the ego vehicle drives in one lane and a vehicle diagonally in front in an adjacent lane starts swerving into the ego lane. The human response to brake or veer off would be immediate and instinctive and can be experienced as a virtual force repelling the ego from the swerving vehicle. This virtual force representation is learned and associated with the specific road object.

Inspired by the above considerations we propose the novel concept of perception fields. Perception fields are a learned representation of road objects in the form of a virtual force field that is “sensed” through the control system of the ego vehicle in the form of ADAS and/or AV software. A field is here defined as a mathematical function which depends on spatial position (or an analogous quantity)

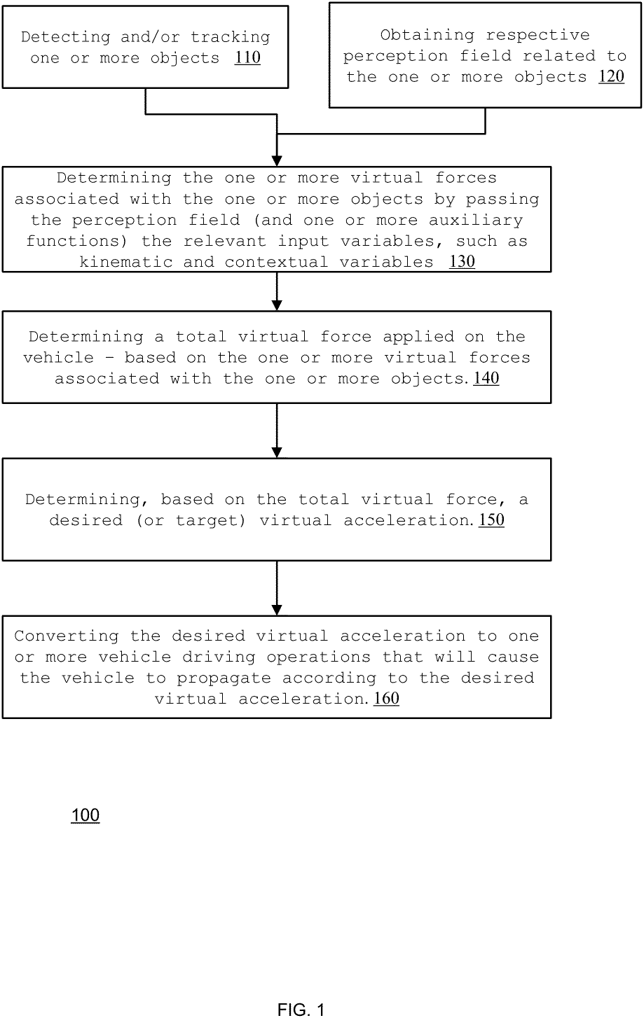

An example of an inference method 100 is illustrates in FIG. 1 and include:

Method 100 may be executed per one or more frames of an environment of the vehicle.

Step 110 of method 100 may include detecting and/or tracking one or more objects (including, for example, one or more road users). The detecting and/or tracking may be done in any manner. The one or more objects may be any object that may affect the behavior of the vehicle. For example - a road user (pedestrian, another vehicle), the road and/or path on which the vehicle is progressing (for example the state of the road or path, the shape of the road - for example a curve, a straight road segments), traffic signs, traffic light, road crossings, a school, a kindergarten, and the like. Step 110 may include obtaining additional information such as kinematic and contextual variables related to the one or more objects. The obtaining may include receiving or generating. The obtaining may include processing the one or more frames to generate the kinematic and contextual variables.

It should be noted that step 110 may include obtaining he kinematic variables (even without obtaining the one or more frames).

Method 100 may also include step 120 of obtaining respective perception field related to the one or more objects. Step 120 may include determining which mapping between objects and should be retrieved and/or used, and the like.

Step 110 (and even step 120) may be followed by step 130 of determining the one or more virtual forces associated with the one or more objects by passing the perception field (and one or more virtual physical model functions) the relevant input variables, such as kinematic and contextual variables.

Step 130 may be followed by step 140 of determining a total virtual force applied on the vehicle -based on the one or more virtual forces associated with the one or more objects. For example - step 140 may include performing a vector weighted sum (or other function) on the one or more virtual forces associated with the one or more objects.

Step 140 may be followed by step 150 of determining, based on the total virtual force, a desired (or target) virtual acceleration - for example based on the equivalent of Newton’s second law. The desired virtual acceleration may be a vector - or otherwise have a direction.

Step 150 may be followed by step 160 of converting the desired virtual acceleration to one or more vehicle driving operations that will cause the vehicle to propagate according to the desired virtual acceleration.

For example - step 160 may include translating the desired acceleration to acceleration or deceleration or changing direction of progress of the vehicle - using gas pedal movement, brake pedal movement and/or steering wheel angle. The translation may be based on a dynamics model of the vehicle with a certain control scheme.

The advantages of perception fields are include, for example - explainability, generalizability and a robustness to noisy input.

Explainability. Representing ego movement as the composition of individual perception fields implies decomposing actions into more fundamental components and is in itself a significant step towards explainability. The possibility to visualize these fields and to apply intuition from physics in order to predict ego motion represent further explainability as compared to common end-to- end, black-box deep learning approaches. This increased transparency also leads to passengers and drivers being able to trust AV or ADAS technology more.

Generalizability. Representing ego reactions to unknown road objects as repellent virtual force fields constitutes an inductive bias in unseen situations. There is a potential advantage to this representation in that it can handle edge cases in a safe way with less training. Furthermore, the perception field model is holistic in the sense that the same approach can be used for all aspects of the driving policy. It can also be divided into narrow driving functions to be used in ADAS such as ACC, AEB, LCA etc. Lastly, the composite nature of perception fields allows the model to be trained on atomic scenarios and still be able to properly handle more complicated scenarios.

Robustness to noisy input: Physical constraints on the time evolution of perception fields in combination with potential filtering of inputs may lead to better handling of noise in the input data as compared to pure filtering of localization and kinematic data.

Physical or virtual forces allow for a mathematical formulation - for example - in terms of a second order ordinary differential equation comprising a so called dynamical system. The benefits of representing a control policy as such is that it is susceptible to intuition from the theory of dynamical systems and it is a simple matter to incorporate external modules such as prediction, navigation, and filtering of in- puts/outputs.

An additional benefit to the perception field approach is that it is not dependent on any specific hardware, and not computationally more expensive than existing methods.

### Training Process

The process for learning perception fields can be of one of two types or a combination thereof, namely behavioral cloning (BC) and reinforcement learning (RL). BC approximates the control policy by fitting a neural network to observed human state-action pairs whereas RL entails learning by trial and error in a simulation environment without reference to expert demonstrations.

One can combine these two classes of learning algorithms by first learning a policy through BC to use it as an initial policy to be fine-tuned using RL. Another way to combine the two approaches is to first learn the so called reward function (to be used in RL) through behavioral cloning to infer what constitutes desirable behavior to humans, and later to train through trial and error using regular RL. This latter approach goes under the name of inverse RL (IRL).

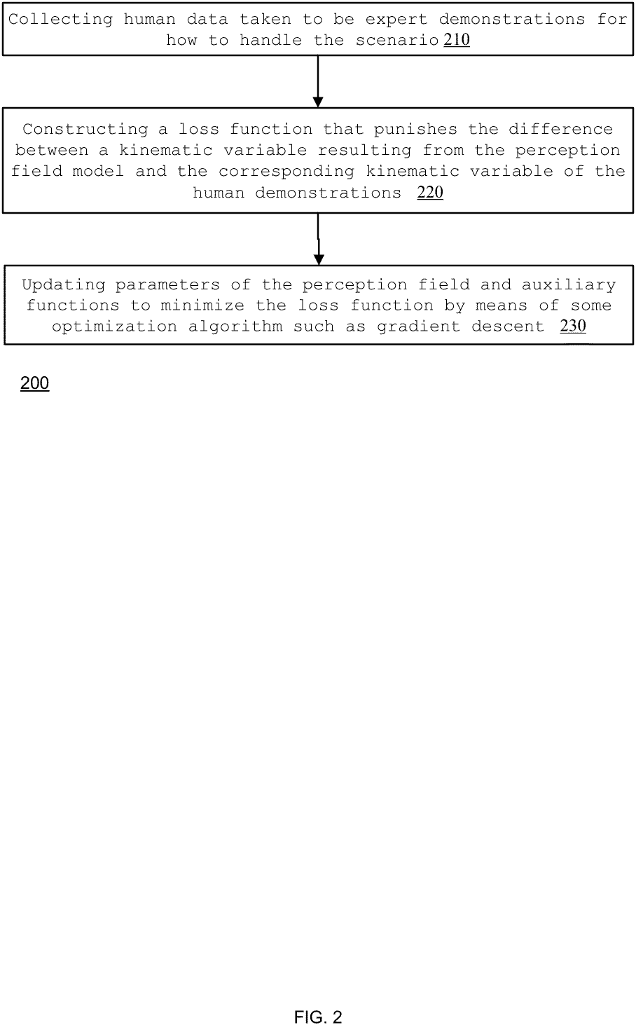

FIG. 2 is an example of a training method 200 employed for learning through BC.

Method 200 may start by step 210 of collecting human data taken to be expert demonstrations for how to handle the scenario.

Step 210 may be followed by step 220 of constructing a loss function that punishes the difference between a kinematic variable resulting from the perception field model and the corresponding kinematic variable of the human demonstrations.

Step 220 may be followed by step 230 of updating parameters of the perception field and auxiliary functions (that may be virtual physical model functions that differ from perception fields) to minimize the loss function by means of some optimization algorithm such as gradient descent.

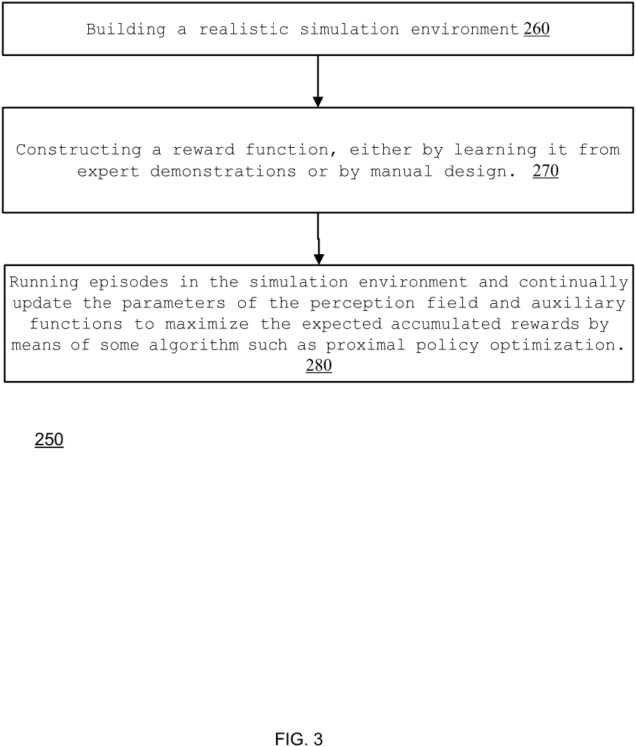

FIG. 3 is an example of a training method 250 employed for reinforcement learning.

Method 250 may start by step 260 of building a realistic simulation environment.

Step 260 may be followed by step 270 of constructing a reward function, either by learning it from expert demonstrations or by manual design.

Step 270 may be followed by step 280 of running episodes in the simulation environment and continually update the parameters of the perception field and auxiliary functions to maximize the expected accumulated rewards by means of some algorithm such as proximal policy optimization.

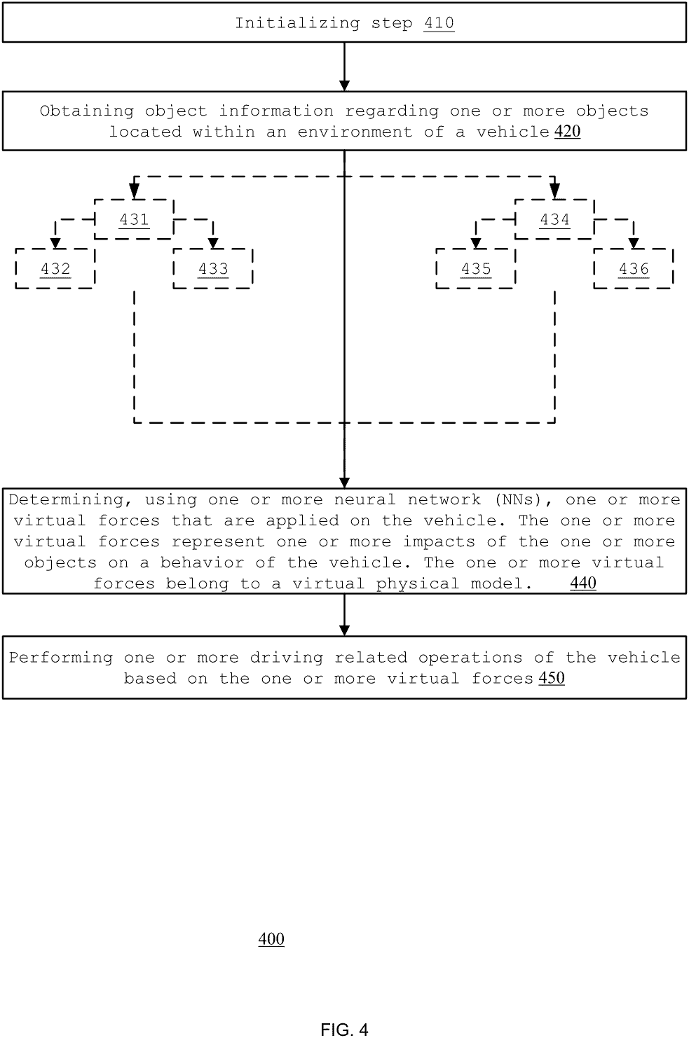

FIG. 4 illustrates an example of method 400.

Method 400 may be for perception fields driving related operations.

Method 400 may start by initializing step 410.

Initializing step 410 may include receiving a group of NNs that are trained to execute step 440 of method 400.

Alternatively, step 410 may include training a group of NNs that to execute step 440 of method 400.

Various example of training the group of NNs are provided below.
The group of NNs may be trained to map the object information to the one or more virtual forces using behavioral cloning.
The group of NNs may be trained to map the object information to the one or more virtual forces using reinforcement learning.
The group of NNs may be trained to map the object information to the one or more virtual forces using a combination of reinforcement learning and behavioral cloning.
The group of NNs may be trained to map the object information to the one or more virtual forces using a reinforcement learning that has a reward function that is defined using behavioral cloning.
The group of NNs may be trained to map the object information to the one or more virtual forces using a reinforcement learning that has an initial policy that is defined using behavioral cloning.
The group of NNs may be trained to map the object information to the one or more virtual forces and one or more virtual physical model functions that differ from the perception fields.
The group of NN may include a first NN and a second NN, wherein the first NN is trained to map the object information to the one or more perception fields and the second NN was trained to map the object information to the one or more virtual physical model functions.

Initializing step 410 may be followed by step 420 of obtaining object information regarding one or more objects located within an environment of a vehicle. Step 410 may be repeated multiple times - and the following steps may also repeated multiple times. The object information may include video, images, audio, or any other sensed information.

Step 420 may be followed by step 440 of determining, using one or more neural network (NNs), one or more virtual forces that are applied on the vehicle.

The one or more NNs may be the entire group of NNs (from initialization step 410) or may be only a part of the group of NNs - leaving one or more non-selected NNs of the group.

The one or more virtual forces represent one or more impacts of the one or more objects on a behavior of the vehicle. The impact may be a future impact or a current impact. The impact may cause the vehicle to change its progress.

The one or more virtual forces belong to a virtual physical model. The virtual physical model is a virtual model that may virtually apply rules of physics (for example mechanical rules, electromagnetic rules, optical rules) on the vehicle and/or the objects.

Step 440 may include at least one of the following steps:
Calculating, based on the one or more virtual forces applied on the vehicle, a total virtual force that is applied on the vehicle.
Determining a desired virtual acceleration of the vehicle based on an total virtual acceleration that is applied on the vehicle by the total virtual force. The desired virtual acceleration may equal the total virtual acceleration - or may differ from it.

Method 400 may also include at least one of step 431, 432, 433, 434, 435 and 436.

Step 431 may include determining a situation of the vehicle, based on the object information.

Step 431 may be followed by step 432 of selecting the one or more NNs based on the situation.

Additionally or alternatively, step 431 may be followed by step 433 of feeding the one or more NNs with situation metadata.

Step 434 may include detecting a class of each one of the one or more objects, based on the object information.

Step 434 may be followed by step 435 of selecting the one or more NNs based on a class of at least one object of the one or more objects.

Additionally or alternatively, step 434 may be followed by step 436 of feeding the one or more NNs with class metadata indicative of a class of at least one object of the one or more objects.

Step 440 may be followed by step 450 of performing one or more driving related operations of the vehicle based on the one or more virtual forces.

Step 450 may be executed without human driver intervention and may include changing the speed and/or acceleration and/or the direction of progress of the vehicle. This may include performing autonomous driving or performing advanced driver assistance system (ADAS) driving operations that may include momentarily taking control over the vehicle and/or over one or more driving related unit of the vehicle. This may include setting, without or without human driver involvement, an acceleration of the vehicle to the desired virtual acceleration.

Step 440 may include suggesting to a driver to set an acceleration of the vehicle to the desired virtual acceleration.

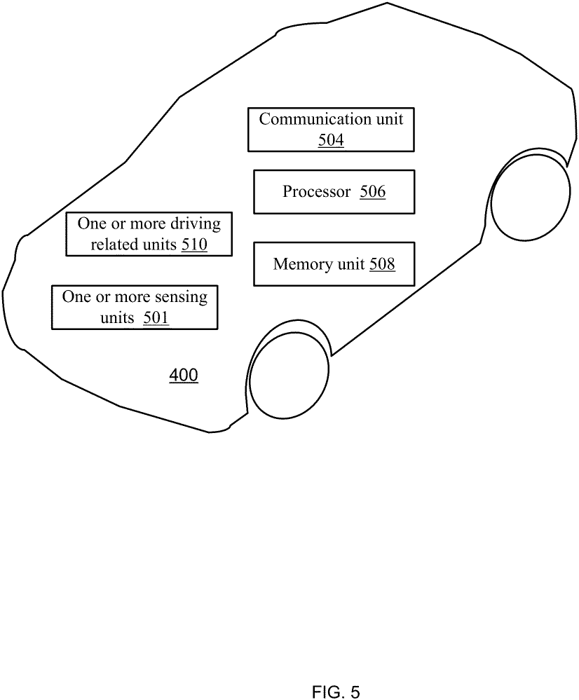

FIG. 5 is an example of a vehicle. The vehicle may include one or more sensing units 501, one or more driving related units 510(such as autonomous driving units, ADAS units, and the like, a processor 560 configured to execute any of the methods, a memory unit 508 for storing instructions and/or method results, functions and the like, and a communication unit 504.

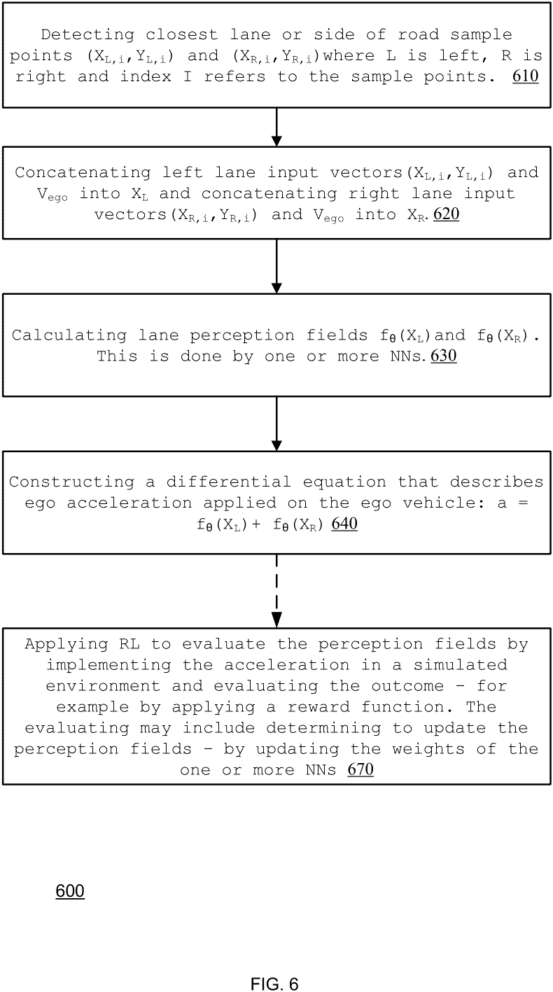

FIG. 6 illustrate examples of a method 600 for lane centering RL with lane sample points as inputs. The lane sample points are located within the environment of the vehicle.

The RL assumes a simulation environment that generated input data in which an agent (ego vehicle) can implement its learned policy (perception fields).

Method 600 may start by step 610 of detecting closest lane or side of road sample points (X_{L},ᵢ, Y_{L},ᵢ) and (X_{R},ᵢ, Y_{R}, ᵢ) where L is left, R is right and index i refers to the sample points. The velocity of the ego vehicle (previously referred to as the vehicle) is denoted V_{ego}.

Step 610 may be followed by step 620 of concentrating left lane input vectors (X_{L}, ᵢ, Y_{L}, ᵢ) and V_{ego} into X_{L} and concentrating right lane input vectors (X_{R},ᵢ,Y_{R},ᵢ) and V_{ego} into X_{R}.

Step 620 may be followed by step 630 of calculating lane perception fields f_{θ}(X_{L})and f_{θ}(X_{R}). This is done by one or more NNs.

Step 630 may be followed by step 640 of constructing a differential equation that describes ego acceleration applied on the ego vehicle: a = f_{θ}(X_{L})+ f_{θ}(X_{R}) .

This may be the output of the inference process. Step 640 may be followed by step 450 (not shown).

The method may include updating the one or more NNs. In this case the RL may assume a reward function that is either learnt based on expert demonstrations or handcrafted), in the example of FIG. 6 the reward function may increase for every timestamp in which the ego vehicle maintains its lane.

The updating may include step 670 of implementing, in a simulation environment and the RL learning algorithm records what happens in the next time step including the obtaining reward.

Step 670 may include using a specific RL algorithm (for example PPO, SAC, TTD3 to sequentially update the network parameters θ in order to maximize average award.

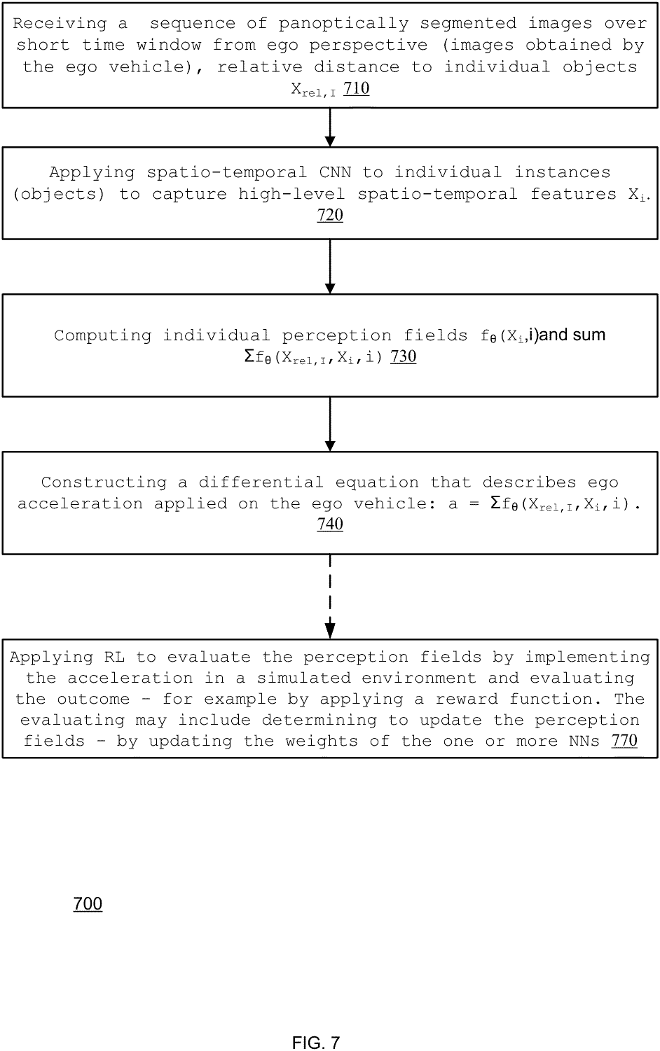

FIG. 7 illustrates method 700 for multi-object RL with visual input.

Step 710 of method 700 may include receiving a sequence of panoptically segmented images over short time window from ego perspective (images obtained by the ego vehicle), relative distance to individual objects Xᵣₑₗ,ᵢ.

Step 710 may be followed by step 720 of applying spatio-temporal CNN to individual instances (objects) to capture high-level spatio-temporal features Xᵢ.

Step 720 may be followed by step 730 of computing individual perception fields f_{θ} (Xᵢ, i) and sum Σf_{θ} (Xᵣₑₗ, _{I}, Xᵢ, i) .

Step 730 may be followed by step 740 of constructing a differential equation that describes ego acceleration applied on the ego vehicle: a = Σf_{θ}(Xᵣₑₗ,_{I}, Xᵢ,i) .

This may be the output of the inference process. Step 740 may be followed by step 450 (not shown).

The method may include updating the one or more network parameters θ using some RL process.

The method may include step 760 of implementing a in the simulation environment and the RL learning algorithm records what happens in the next time step, including the obtained reward.

The RL may assume a reward function that is either learned based on expert demonstrations or handcrafted.

Step 760 may be followed by step 770 of using specific RL algorithm such as PPO, SAC, TTD3 to sequentially update the network parameters θ in order to maximize average reward.

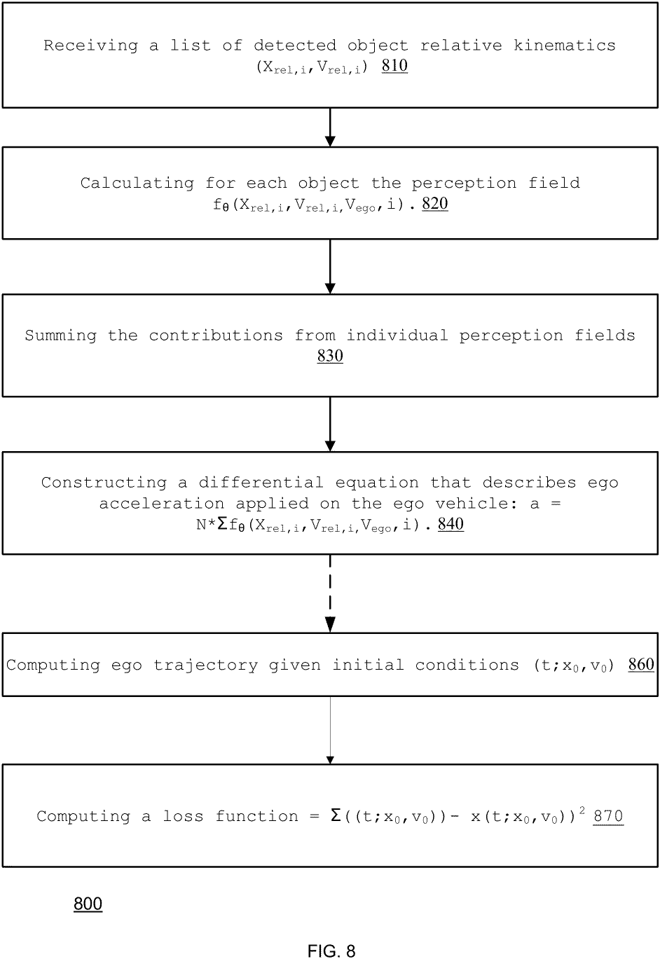

FIG. 8 illustrates method 800 for multi-object BC with kinematics input.

Step 810 of method 800 may include receiving a list of detected object relative kinematics (Xᵣₑₗ, ᵢ, Vᵣₑₗ, ᵢ) wherein Xᵣₑₗ,ᵢ is a relative location of detected object i-in relation to the ego vehicle and Vᵣₑₗ,ᵢ is a relative velocity of detected object i- in relation to the ego vehicle. Also receiving the ego vehicle velocity V_{ego}.

Step 810 may be followed by step 820 of calculating for each object the perception field f _{θ} (Xᵣₑₗ,ᵢ, Vᵣₑₗ,ᵢ, V_{ego}, i) .

Step 820 may be followed by step 830 of summing the contributions from individual perception fields. Step 830 may also include normalizing so that the magnitude of the resulting 2d vector is equal to the highest magnitude of the individual terms _{:} N*Σf_{θ}(Xᵣₑₗ,ᵢ, Vᵣₑₗ,ᵢ,V_{ego}, i) .

Step 830 may be followed by step 840 of constructing a differential equation that describes ego acceleration applied on the ego vehicle: a = N*Σf_{θ}(Xᵣₑₗ,ᵢ, Vᵣₑₗ,ᵢ,V_{ego},i) .

This may be the output of the inference process. Step 840 may be followed by step 450 (not shown).

The method may include updating the one or more network parameters.

The method may include step 860 of computing ego trajectory given initial conditions X̅ (t;x₀, v₀) .

Step 860 may be followed by step 870 of computing a loss function = Σ (X̅ (t; x₀, v₀) ) - x (t; x₀, v₀) ) ² . And propagating the loss accordingly.

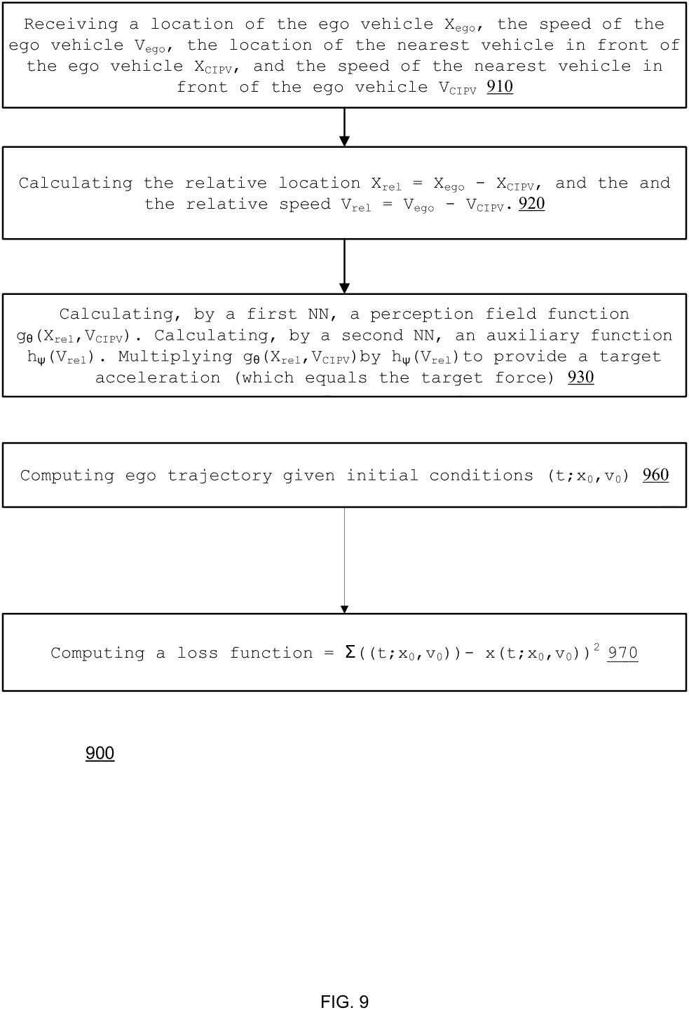

FIG. 9 illustrates method 900 of inference with the addition of a loss function for an adaptive cruise control model implemented with kinematic variables as inputs.

Step 910 of method 900 may include receiving a location of the ego vehicle X_{ego}, the speed of the ego vehicle V_{ego}, the location of the nearest vehicle in front of the ego vehicle X_{CIPV}, and the speed of the nearest vehicle in front of the ego vehicle V_{CIPV}.

Step 910 may be followed by step 920 of calculating the relative location Xᵣₑₗ = X_{ego} - X_{CIPV}, and the and the relative speed Vᵣₑₗ = V_{ego} - V_{CIPV}.

Step 920 may be followed by step 930 of:
Calculating, by a first NN, a perception field function g_{θ} (Xᵣₑₗ, V_{CIPV}) .
. Calculating, by a second NN, an auxiliary function hψ(Vᵣₑₗ) .
Multiplying g_{θ} (Xᵣₑₗ, V_{CIPV}) by hψ (Vᵣₑₗ) to provide a target acceleration (which equals the target force).

This may be the output of the inference process. Step 930 may be followed by step 450 (not shown).

The method may include updating the one or more NN parameters.

The method may include step 960 of computing ego trajectory given initial conditions X̅(t;x₀,v₀) .

Step 960 may be followed by step 970 of computing a loss function = Σ (X̅ (t; x₀, v₀) ) - x (t; x₀, v₀) ) ² . And propagating the loss accordingly.

### Field Related Driving

Perception fields are a novel computational framework to generate driving policies in an autonomous ego-vehicle in different traffic environments (e.g., highway, urban, rural) and for different driving tasks (e.g., collision avoidance, lane keep- ing, ACC, overtaking, etc). Perception fields are attributes of road objects and encode force fields, which emerge from each road object i of category c (e.g., other vehicles, pedestrians, traffic signs, road boundaries, etc.), and act on the ego vehicle, inducing driving behavior. The key to obtaining desirable driving behavior from a perception field representation of the ego environment is modeling the force fields so that they are general enough to allow for versatile driving behaviors but specific enough to allow for efficient learning using human driving data. The application of perception fields has several advantages over existing methods (e.g., end-to-end approaches), such as task-decomposition and enhanced explainability and generalization capabilities, resulting in versatile driving behavior.

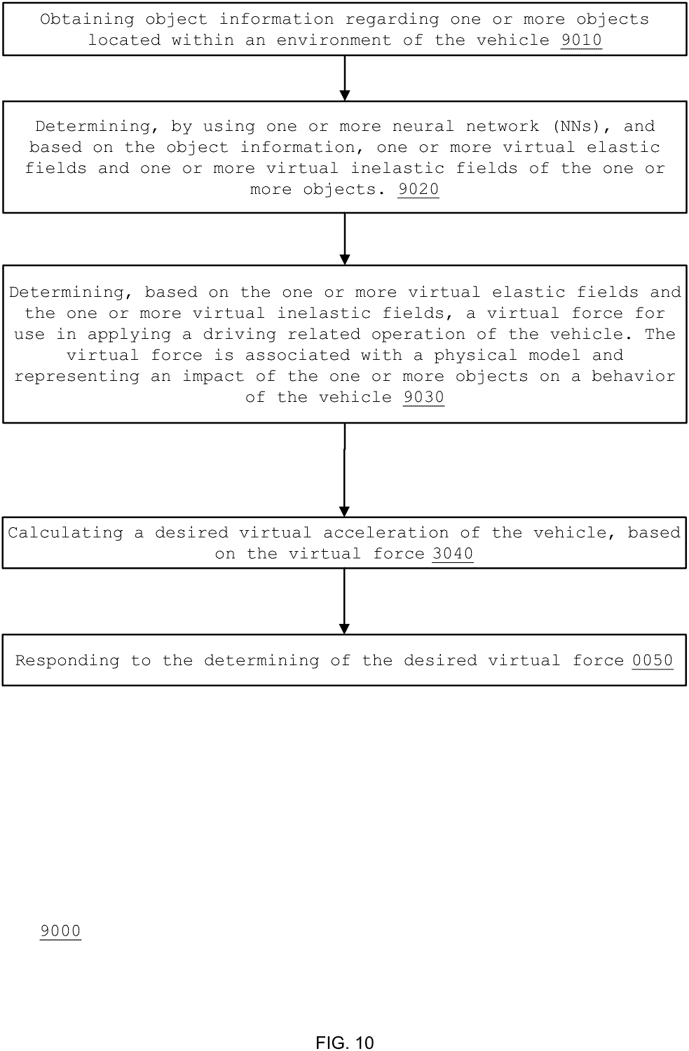

FIG. 10 illustrates an example of a method 9000 for field related driving.

According to an embodiment, method 2000 starts by step 2010 of obtaining object information regarding one or more objects located within an environment of the vehicle.

According to an embodiment, step 2010 also includes analyzing the object information. The analysis may include determining location information and/or movement information of the one or more objects. The location information and the movement information may include the relative location of the one or more objects (in relation to the vehicle) and/or the relative movement of the one or more objects (in relation to the vehicle).

According to an embodiment, step 2010 is followed by step 2020 of determining, by using one or more neural network (NNs), and based on the object information, one or more virtual elastic fields and one or more virtual inelastic fields of the one or more objects.

According to an embodiment, the one or more virtual elastic fields are one or more virtual elastic force fields, and wherein the one or more virtual inelastic fields are one or more virtual inelastic force fields.

According to an embodiment, the one or more virtual elastic fields are one or more virtual elastic potential fields, and wherein the one or more virtual inelastic fields are one or more virtual inelastic potential fields.

According to an embodiment, step 2020 is followed by step 2030 of determining, based on the one or more virtual elastic fields and the one or more virtual inelastic fields, a virtual force for use in applying a driving related operation of the vehicle. The virtual force is associated with a physical model and representing an impact of the one or more objects on a behavior of the vehicle.

According to an embodiment, the one or more virtual elastic fields are one or more virtual elastic potential fields, and wherein the one or more virtual inelastic fields are one or more virtual inelastic potential fields - and step 2030 includes determining of the virtual force by calculating gradients of the one or more virtual elastic potential fields and calculating gradients of the one or more virtual inelastic potential fields.

According to an embodiment, the one or more virtual elastic fields are one or more virtual elastic force fields, and wherein the one or more virtual inelastic fields are one or more virtual inelastic force fields - and step 2030 includes determining of the virtual force based on mechanical rules related to the gravitation of objects.

According to an embodiment, step 2030 is followed by step 2040 of calculating a desired virtual acceleration of the vehicle, based on the virtual force.

Step 2040 may be executed based on assumption regarding a relationship between the virtual force and a desired virtual acceleration of the vehicle. For example -the virtual force may have a virtual acceleration (that is virtually applied on the vehicle) and the desired virtual acceleration of the vehicle may counter the virtual acceleration that is virtually applied on the vehicle.

According to an embodiment - the desired virtual acceleration has a same magnitude as the virtually applied acceleration - but may be directed in an opposite direction.

According to an embodiment - the desired virtual acceleration has an magnitude that differs from the magnitude of the virtually applied acceleration.

According to an embodiment - the desired virtual acceleration has a direction that is not opposite to a direction of the virtually applied acceleration.

According to an embodiment, step 2040 is followed by step 2050 of responding to the determining of the desired virtual acceleration.

According to an embodiment, step 2040 may include at least one of:
Generating a graphical user interface representing the one or more virtual elastic fields and the one or more virtual inelastic fields.
Triggering an execution of a driving related operation.
Requesting or instructing an execution of a driving related operation.
Triggering a calculation of a driving related operation, based on the desired virtual acceleration.
Requesting or instructing a calculation of a driving related operation, based on the desired virtual acceleration
Sending information about the desired virtual acceleration to a control unit of the vehicle.
Taking control over the vehicle - transferring the control from the driver to an autonomous driving unit.

Examples of elastic and inelastic fields are listed below.

Objects such as road users may be classified to categories (for example, vehicle, pedestrian, and the like), a virtual field of object i that belongs to a category c may be a

In particular, a virtual potential field of a single road object i of category c may be composed of an elastic potential field (also referred to as a conservative or energy conservative field) and an inelastic (also referred to as a dissipative directional field).

Per object, the elastic potential field of the object and the inelastic potential field of the object may be the only required feature of a virtual force associated with the object. There may be no need for additional information for calculating the virtual force.

The elastic potential field and the inelastic potential field may be calculated by applying one or more functions on one or more variables such as a relative speed of an object, a relative distance of the object, a relative angle of the object, or a combination thereof. The relativity is in relation to the vehicle for which method 9000 is executed (also referred to as an ego vehicle). The one or more functions may be allocated per object and/or per object category.

For example:
The elastic potential field related to object i of category c may be calculated by applying function g₁,_{c} on the relative distance - xᵢ (g₁,_{c} (xᵢ) .
The inelastic potential field related to object i of category c may be calculated by:
   i. Applying function h_{c} on the relative velocity vᵢ and the relative Thetaᵢ - h_{c}(vᵢ, Thetaᵢ) .
   ii. Applying function g₂,_{c} on the relative distance xᵢ - (g₂,_{c} (xᵢ) .
   iii. Multiplying h_{c}(vᵢ, Thetaᵢ) by xᵢ (g₂,_{c}(xᵢ) to provide a product.

In this example the potential field related to object i of a category c can be:

$${\text{U}}_{\text{c}} {\text{(X}}_{\text{i}} {\text{, V}}_{\text{i}} {\text{, Theta}}_{\text{i}} {\text{) = g}}_{\text{1,c}} {\text{(x}}_{\text{i}} {\text{) + h}}_{\text{c}} {\text{(v}}_{\text{i}} {\text{, Theta}}_{\text{i}} \text{)} * {\text{x}}_{\text{i}} {\text{(g}}_{\text{2,c}} {\text{(x}}_{\text{i}} \text{)}$$

Yet for another example:
The elastic potential field related to object i of category c may be calculated by applying function g₁,_{c} on the relative distance xᵢ -(g₁,_{c}(xᵢ).
The inelastic potential field related to object i of category c may be calculated by:
   i. Applying function j_{c} on the relative velocity vᵢ - j_{c}(vᵢ)
   ii. Applying function l_{c} on the relative Thetaᵢ l_{c}(Thetaᵢ) .
   iii. Applying function g₂,_{c} on the relative distance xᵢ - (g₂,_{c} (xᵢ)).
   iv. Multiplying j_{c} (vᵢ) by l_{c} (Thetaᵢ) by (g₂,_{c}(xᵢ) to provide a product.

In this example the potential field related to object i of a category c can be:

$$\begin{matrix}{\text{U}}_{\text{c}} \left({\text{x}}_{\text{i}} \text{,} {\text{v}}_{\text{i}} \text{,} {\text{Theta}}_{\text{i}}\right) \text{=} {\text{g}}_{\text{1,} \text{C}} \left({\text{x}}_{\text{i}}\right) \text{+} {\text{j}}_{\text{C}} \left({\text{v}}_{\text{i}}\right) {\text{*l}}_{\text{C}} \left({\text{Theta}}_{\text{i}}\right) \text{*} \\ {\text{x}}_{\text{i}} \left({\text{g}}_{\text{2,} \text{C}} \left({\text{x}}_{\text{i}}\right)\right)\end{matrix}$$

One or more (and even each one of) functions of g₁,_{c} (xᵢ), h_{c} (vᵢ, Thetaᵢ), j_{c} (vᵢ), l_{c} (Thetaᵢ) and xᵢ (g₂,_{c} (xᵢ) can be implemented (for example can be calculated by) one or more deep neural networks.

One or more (and even each one of) functions of g₁,_{c}(xᵢ), h_{c}(vᵢ, Thetaᵢ), j_{c}(vᵢ), l_{c} (Thetaᵢ) and xᵢ (g₂,_{c} (xᵢ) can be learnt from human expert data using machine learning methods, such as behavioral cloning (BC) and/or inverse reinforcement learning (IRL).

The virtual force applied by road user i of category c can be calculated by a negative gradient of the dynamic potential field. Fᵢ = negative gradient of U_{c} (xᵢ, vᵢ, Thetaᵢ) - in respect to one of the variables -for example in relation to xᵢ.

By composition of various perception fields, complex and safe driving behavior can be generated in multiple scenarios, such as lane keeping/centering, adaptive cruise control, emergency braking and overtaking tasks.

By calculating separate functions for different variables the learning process can be simplified.

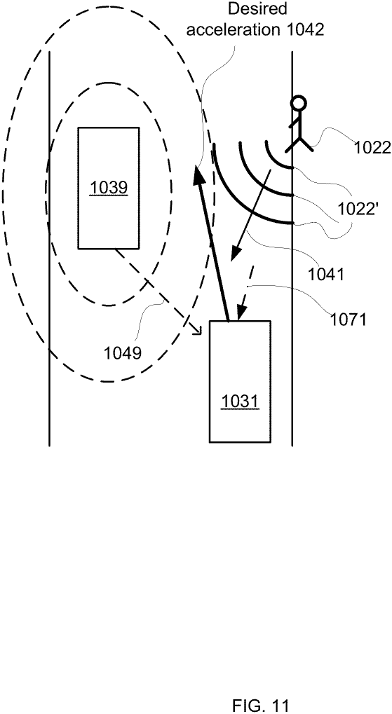

FIG. 11 illustrates an example of a scene.

FIG. 11 illustrates an example of vehicle 1031 that is located within a segment of a first road.

A pedestrian 1022 starts crossing the segment -in front of the vehicle 1301. The pedestrian is represented by a pedestrian virtual field (illustrated by virtual equipotential field lines 1022′ and directional vector 1041) that repels vehicle 1031.

Another vehicle 1039 drives at an opposite lane, has a other vehicle virtual field 1049 and applies a another virtual force 1049 on vehicle 1031.

The virtual force applied on vehicle 1031 (as a result of the pedestrian and the other vehicle) is denoted 1071. FIG. 11 also illustrates the desired acceleration 1042 of the vehicle.

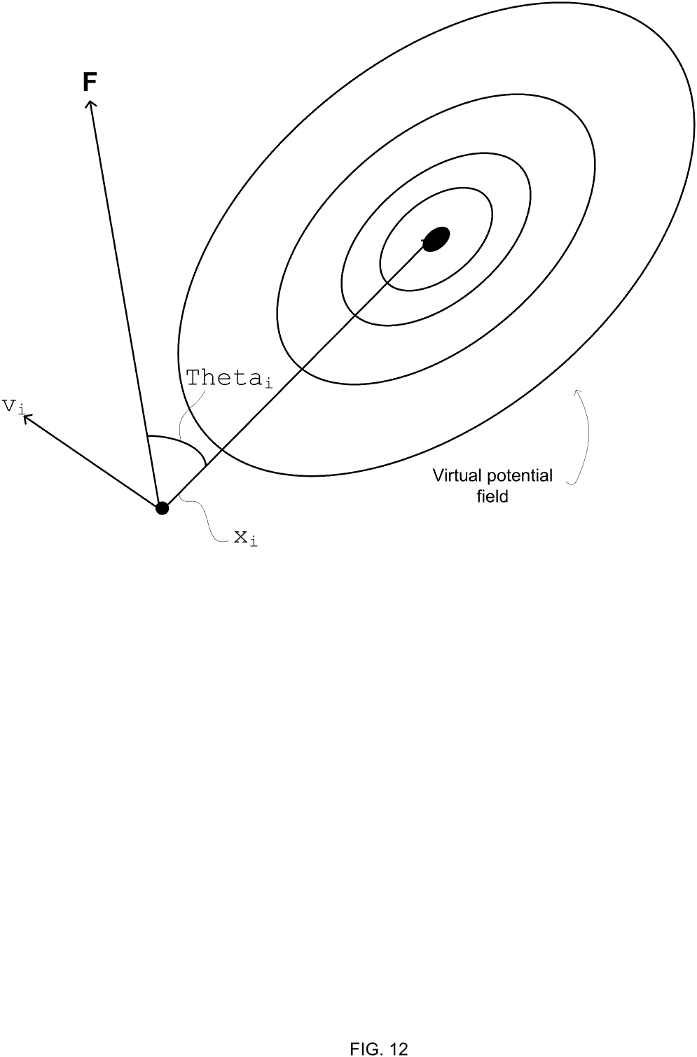

FIG. 12 illustrates an example of a potential field generated by road object i and resulting force F acting on the ego vehicle. The relative distance (xᵢ), relative velocity (vᵢ) and relative direction (Thetaᵢ - θᵢ ) of the ego vehicle are shown.

In the foregoing specification, the invention has been described with reference to specific examples of embodiments of the invention. It will, however, be evident that various modifications and changes may be made therein without departing from the broader spirit and scope of the invention as set forth in the appended claims. Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein. Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one. Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality. Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality. Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner. However, other modifications, variations and alternatives are also possible. The specifications and drawings are, accordingly, to be regarded in an illustrative rather than in a restrictive sense. In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention. It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination. It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for field related driving, the method comprises:
obtaining object information regarding one or more objects located within an environment of the vehicle;
determining, by using one or more neural network (NNs), and based on the object information, one or more virtual elastic fields and one or more virtual inelastic fields of the one or more objects; and
determining, based on the one or more virtual elastic fields and the one or more virtual inelastic fields, a virtual force for use in applying a driving related operation of the vehicle, wherein the virtual force is associated with a physical model and representing an impact of the one or more objects on a behavior of the vehicle.

2. The method according to claim 1, wherein the one or more virtual elastic fields are one or more virtual elastic force fields, and wherein the one or more virtual inelastic fields are one or more virtual inelastic force fields.

3. The method according to claim 1, wherein the one or more virtual elastic fields are one or more virtual elastic potential fields, and wherein the one or more virtual inelastic fields are one or more virtual inelastic potential fields.

4. The method according to claim 3, wherein the determining of the virtual force comprises calculating gradients of the one or more virtual elastic potential fields and calculating gradients of the one or more virtual inelastic potential fields.

5. The method according to claim 1 comprising generating a graphical user interface representing the one or more virtual elastic fields and the one or more virtual inelastic fields.

6. The method according to claim 1, comprising calculating a desired virtual acceleration of the vehicle, based on the virtual force.

7. The method according to claim 1, comprising performing the driving related operation.

8. A non-transitory computer readable medium for field related driving, the non-transitory computer readable medium stores instructions for:
obtaining object information regarding one or more objects located within an environment of the vehicle;
determining, by using one or more neural network (NNs), and based on the object information, one or more virtual elastic fields and one or more virtual inelastic fields of the one or more objects; and
determining, based on the one or more virtual elastic fields and the one or more virtual inelastic fields, a virtual force for use in applying a driving related operation of the vehicle, wherein the virtual force is associated with a physical model and representing an impact of the one or more objects on a behavior of the vehicle.

9. The non-transitory computer readable medium according to claim 8, wherein the one or more virtual elastic fields are one or more virtual elastic force fields, and wherein the one or more virtual inelastic fields are one or more virtual inelastic force fields.

10. The non-transitory computer readable medium according to claim 8, wherein the one or more virtual elastic fields are one or more virtual elastic potential fields, and wherein the one or more virtual inelastic fields are one or more virtual inelastic potential fields.

11. The non-transitory computer readable medium according to claim 10, wherein the determining of the virtual force comprises calculating gradients of the one or more virtual elastic potential fields and calculating gradients of the one or more virtual inelastic potential fields.

12. The non-transitory computer readable medium according to claim 8, comprising generating a graphical user interface representing the one or more virtual elastic fields and the one or more virtual inelastic fields.

13. The non-transitory computer readable medium according to claim 8, comprising calculating a desired virtual acceleration of the vehicle, based on the virtual force.

14. The non-transitory computer readable medium according to claim 8, comprising performing the driving related operation.
